(19) United States
(12) Patent Application Publication
(10) Pub. No.: US 2021/0192252 A1
(43) Pub. Date: Jun. 24, 2021

(54) METHOD AND APPARATUS FOR FILTERING IMAGES AND ELECTRONIC DEVICE

(71) Applicant: SENSETIME INTERNATIONAL PTE. LTD., SINGAPORE (SG)

(72) Inventors: Jin WU, SINGAPORE (SG); Kaige CHEN, SINGAPORE (SG); Shuai YI, SINGAPORE (SG)

(21) Appl. No.: 16/901,184

(22) Filed: Jun. 15, 2020

Related U.S. Application Data
(63) Continuation of application No. PCT/IB2020/053494, filed on Apr. 14, 2020.

(30) Foreign Application Priority Data
Dec. 24, 2019 (SG) 10201913146V

(51) Int. Cl. G06K 9/20; G06K 9/00; G06K 9/03

(52) U.S. Cl. CPC G06K 9/2054; G06K 2209/21; G06K 9/036; G06K 9/00711

(57) ABSTRACT

Disclosed are a method and apparatus for filtering images and an electronic device. The method includes: obtaining a first image, where the first image is an image frame in a video stream obtained by collecting images of a target area; obtaining a first detection result of a target object in the first image by detecting the first image; determining a state of a target object with to-be-determined state according to the first detection result of the target object in the first image and a second detection result of the target object with to-be-determined state; and determining a quality level of an image in a bounding box of the target object with to-be-determined state according to the state of the target object with to-be-determined state, where the bounding box of the target object with to-be-determined state is determined according to the first detection result of the target object with to-be-determined state.

### CROSS REFERENCE TO RELATED APPLICATIONS

This application is a continuation of International Application No. PCT/IB2020/053494, filed on Apr. 14, 2020, which claims priority to Singaporean Patent Application No. 10201913146V entitled “METHOD AND APPARATUS FOR FILTRATING IMAGES AND ELECTRONIC DEVICE” and filed on Dec. 24, 2019, all of which are incorporated herein by reference in their entirety.

### TECHNICAL FIELD

The present disclosure relates to the field of computer vision technologies, and in particular, to a method and apparatus for filtering images and an electronic device.

### BACKGROUND

In recent years, with the continuous development of an artificial intelligence technology, the artificial intelligence technology has achieved relatively good results in computer vision, speech recognition and other aspects. In some relatively special scenarios, such as table game scenarios, there is a need to identify an object on a table.

### SUMMARY

The present disclosure provides a method solution of filtering images.

Specifically, the present disclosure is implemented through the following technical solutions.

According to a first aspect of embodiments of the present disclosure, a method of filtering images is provided. The method includes: obtaining a first image, where the first image is an image frame in a video stream obtained by collecting images for a target area; obtaining a first detection result of a target object in the first image by detecting the first image; determining a state of a target object with to-be-determined state according to the first detection result of the target object in the first image and a second detection result of the target object with to-be-determined state, where the target object with to-be-determined state is a target object in the first image, the second detection result of the target object with to-be-determined state is a detection result of the target object with to-be-determined state in a second image obtained by detecting the second image, the second image is at least one image frame in N image frames adjacent to the first image in the video stream, and N is a positive integer; and determining a quality level of an image in a bounding box of the target object with to-be-determined state according to the state of the target object with to-be-determined state, wherein the bounding box of the target object with to-be-determined state is determined according to the first detection result of the target object with to-be-determined state.

According to a second aspect of embodiments of the present disclosure, an apparatus for filtering images is provided. The apparatus includes: an image obtaining unit, configured to obtain a first image, wherein the first image is an image frame in a video stream obtained by collecting images for a target area; a detection result obtaining unit, configured to obtain a first detection result of a target object in the first image by detecting the first image; a state determining unit, configured to determine a state of a target object with to-be-determined state according to the first detection result of the target object in the first image and a second detection result of the target object with to-be-determined state, where the target object with to-be-determined state is a target object in the first image, the second detection result of the target object with to-be-determined state is a detection result of the target object with to-be-determined state in a second image obtained by detecting the second image, the second image is at least one image frame in N image frames adjacent to the first image in the video stream, and N is a positive integer; and a quality determining unit, configured to determine a quality level of an image in a bounding box of the target object with to-be-determined state according to the state of the target object with to-be-determined state, wherein the bounding box of the target object with to-be-determined state is determined according to the first detection result of the target object with to-be-determined state.

According to a third aspect, embodiments of the present disclosure also provide an electronic device. The electronic device includes: a memory and a processor, where the memory is configured to store computer instructions executed by the processor, and the processor is configured to execute the computer instructions to implement the method of filtering images according to the first aspect.

According to a fourth aspect, embodiments of the present disclosure also provide a non-volatile computer-readable storage medium. The computer-readable storage medium storing a computer program. When the program is executed by a processor, causes the processor to implement the method of filtering images according to the first aspect.

In the embodiments of the present disclosure, the state of the target object with to-be-determined state in the first image is determined according to the first detection result of the target object in the first image in a video stream obtained by collecting images for a target area, and according to a second detection result of the target object with to-be-determined state in the second image, where the second image is at least one image frame in multiple image frames adjacent to the first image. Thus, the quality level of the image in the bounding box of the target object with to-be-determined state is determined, and the frame image in the video stream is filtered according to the determined quality level, thereby improving the identification efficiency.

It should be understood that the above general description and the following detailed description are merely exemplary and explanatory, and are not intended to limit the present disclosure.

### BRIEF DESCRIPTION OF THE DRAWINGS

The accompanying drawings, which are incorporated in and constituted a part of the specification, illustrate embodiments consistent with the present disclosure and serve to explain the technical solutions of the present disclosure together with the specification.

FIG. 1 is a flowchart of a method of filtering images provided by at least one embodiment of the present disclosure.

FIG. 2 is a schematic diagram of an application scenario provided by at least one embodiment of the present disclosure.

FIG. 3A is a schematic diagram of a target object provided by at least one embodiment of the present disclosure.

FIG. 3B is a schematic diagram of another target object provided by at least one embodiment of the present disclosure.

FIG. 4 is a flowchart of a method of determining a motion state of a target object with to-be-determined state provided by at least one embodiment of the present disclosure.

FIG. 5 is a schematic diagram of an apparatus for filtering images provided by at least one embodiment of the present disclosure.

FIG. 6 is a schematic structural diagram of an electronic device provided by at least one embodiment of the present disclosure.

### DETAILED DESCRIPTION OF THE EMBODIMENTS

Exemplary embodiments will be described in detail herein, examples of which are illustrated in the accompanying drawings. If the drawings are involved in the following description, the same numeral in different drawings refers to the same or similar elements, unless otherwise indicated. The implementations described in the following exemplary embodiments do not represent all implementations consistent with the present application. Instead, the implementations are merely examples of apparatuses and methods consistent with some aspects of the present application as detailed in the appended claims.

The terms used in the present application are merely intended to describe particular embodiments, and are not intended to limit the present application. Terms determined by “a”, “the” and “said” in their singular forms in the present application and the appended claims are also intended to include plurality, unless other meanings are clearly indicated in the context. It should also be understood that the term “and/or” as used herein refers to and includes any and all possible combinations of one or more associated listed items. In addition, the term “at least one” herein means any one of a plurality of items or any combination of at least two of a plurality of items.

It should be understood that although the terms such as “first”, “second”, “third” and the like may be used in the present application to describe various information, such information should not be limited to these terms. These terms are only used to distinguish the one category of information from another. For example, first information may also be referred to as second information without departing from the scope of the present application. Similarly, the second information may also be referred to as the first information. Depending on the context, the word “if” as used herein may be interpreted as “when” or “upon” or “in response to determination”.

To make a person skilled in the art well understand the technical solutions in the embodiments of the present disclosure, and make the objects, features, and advantages in the embodiments of the present disclosure apparently, the technical solutions in the embodiments of the present disclosure are further described below in detail with reference to the accompanying drawings.

In an exemplary table game scenario of the present disclosure, multiple people sit around a game table which may include multiple game areas, and different game areas may have different game meanings. Moreover, in a multiplayer game, users may play the game with redeemed items (such as game coins).

For example, the user may exchange the redeemed item with some items belonging to the user, and the redeemed items may be placed in different game areas of the game table to play the game. For example, a first user may exchange multiple self-owned watercolor pens for chess pieces used in a game, and play the game with the chess pieces among different game areas on the game table according to game rules. If a second user wins the first user in the game, the chess pieces of the first user may belong to the second user. For example, the game described above is suitable for entertainment activities among family members during leisure time such as holidays.

With the continuous development of an artificial intelligence technology, many places are trying to perform intelligent construction. For example, one of the topics is the construction of intelligent game places. Then, one of the requirements of the intelligent game place is to automatically identify objects on the table in the game, for example, to automatically identify the number of redeemed items.

FIG. 1 is a flowchart of a method of filtering images provided by at least one embodiment of the present disclosure. As shown in FIG. 1, the method may include steps 101 to 104.

At step 101, a first image is obtained, where the first image is an image frame in a video stream obtained by collecting images for a target area.

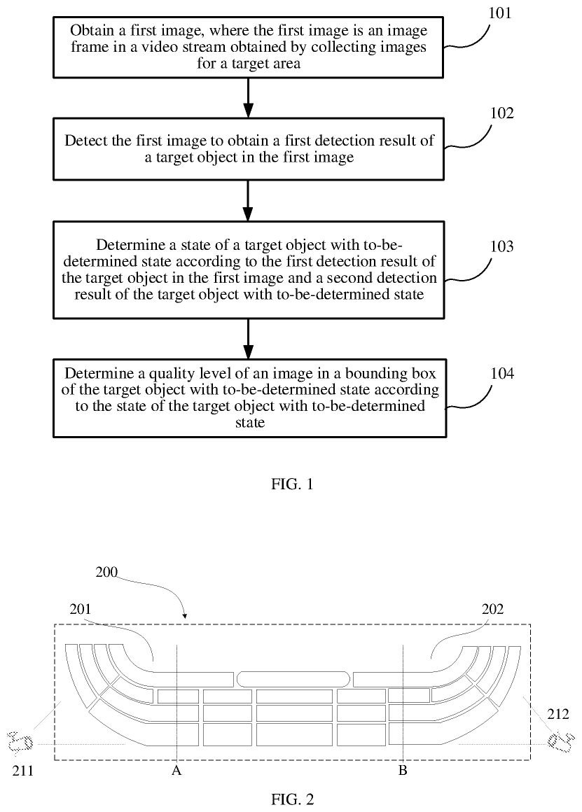

In the embodiments of the present disclosure, the target area is an area on which a target object is placed. For example, the target area may be a plane (e.g., a desktop), a container (e.g., a box), or the like. The target object may be one or more objects. In some relatively common situations, the target object is a sheet-shaped object with various shapes, such as game coins, banknotes, cards, and so on. FIG. 2 shows a partial schematic diagram of a game table in a table game scenario. The game table includes multiple target areas, where each closed area represents one target area. The target object in this scenario is, for example, game coins on the game table.

At step 102, the first image is detected to obtain a first detection result of a target object in the first image.

In some embodiments, the first image may be input to a pre-trained target detection network to obtain the first detection result of the target object in the first image. The target detection network may be trained by using sample images annotated with a category of the target object. The first detection result includes a bounding box of each target object, a position of the bounding box, and a classification result of each target object.

At step 103, a state of a target object with to-be-determined state is determined according to the first detection result of the target object in the first image and a second detection result of the target object with to-be-determined state.

In the embodiments of the present disclosure, the target object with to-be-determined state is an target object in the first image, the second detection result of the target object with to-be-determined state is a detection result of the target object with to-be-determined state in a second image obtained by detecting the second image, where the second image is at least one image frame in N image frames adjacent to the first image in the video stream, and N is a positive integer.

In some embodiments, the state of the target object with to-be-determined state includes an occlusion state and a motion state. The occlusion state represents whether the target object with to-be-determined state is occluded by other target object, and the motion state represents whether the target object with to-be-determined state satisfies a preset motion state condition. Persons skilled in the art should understand that the state of the target object with to-be-determined state may also include other states, and is not limited to the states described above.

In a case that the first image is a first image frame in the video stream, detection may be performed according to at least one image frame in N image frames located behind the first image, i.e., the second image, to obtain the detection result of the target object with to-be-determined state in the second image, thereby determining the state of the target object with to-be-determined state. In a case that the first image is not the first image frame in the video stream, detection may be performed according to at least one image frame in N image frames located in front of the first image, i.e., the second image, to obtain the detection result of the target object with to-be-determined state in the second image. Thus, the state of the target object with to-be-determined state is determined.

At step 104, a quality level of an image in a bounding box of the target object with to-be-determined state is determined according to the state of the target object with to-be-determined state.

In the embodiments of the present disclosure, the bounding box of the target object with to-be-determined state is determined according to the first detection result of the target object with to-be-determined state.

In one example, for a bounding box of the target object with to-be-determined state in the first detection result, an image in the bounding box may be cropped, and the quality level of the cropped image is determined according to the state of the target object with to-be-determined state. For a bounding box of the target object with to-be-determined state in the first detection result, the quality level of the image in the bounding box of the target object with to-be-determined state in the first image may be determined according to the state of the target object with to-be-determined state.

In the embodiments of the present disclosure, the state of the target object with to-be-determined state in the first image is determined according to the first detection result of the target object in the first image in the video stream obtained by collecting images for the target area, and according to a second detection result of the target object with to-be-determined state in the second image in adjacent multiple image frames. Then the quality level of the image in the bounding box of the target object with to-be-determined state is determined. Further, high-quality images for the target objects with to-be-determined state may be filtered according to the quality level, thereby improving the identification efficiency.

In some embodiments, the state of the target object with to-be-determined state includes an occlusion state and a motion state. The state of the target object with to-be-determined state may be determined in the following ways.

First, a motion state of the target object with to-be-determined state is determined according to the first detection result of the target object with to-be-determined state and the second detection result of the target object with to-be-determined state. Change in position of the target object with to-be-determined state is determined according to the first detection result of the target object with to-be-determined state in the first image (also called a current image frame) and a second detection result of the target object with to-be-determined state in the second image (an image frame in front of the first image or an image frame behind the first image). The motion state of the target object with to-be-determined state may be determined by combining the change in position and a time interval between collections of the first image and the second image.

Next, whether the motion state of the target object with to-be-determined state satisfies a preset motion state condition is determined.

In one example, the preset motion state condition may be set as: motion speed is less than a set motion speed threshold.

Motion speed of the target object with to-be-determined state may be determined according to the time interval and the change in position of the target object with to-be-determined state in the first image and the second image. In response to that the motion speed is zero, it may be determined that the target object with to-be-determined state is in a still state, and then it may be determined that the motion state satisfies the preset motion state condition. In response to that the motion speed is less than the motion speed threshold, it may also be determined that the motion state satisfies the preset motion state condition. Persons skilled in the art should understand that the motion speed threshold may be specifically set according to requirements to the image quality, which is not limited in the embodiments of the present disclosure.

In response to that the motion state of the target object with to-be-determined state satisfies the preset motion state condition, an occlusion state of the target object with to-be-determined state is determined according to the first detection result of the target object with to-be-determined state and a first detection result of one or more other target objects in the first image except the target object with to-be-determined state.

In a case that the motion state of the target object with to-be-determined state dissatisfies the set state condition, for example, when the motion speed is greater than or equal to the motion speed threshold, it is indicated that the motion speed of the target object with to-be-determined state is relatively high. In such case, for an object on the game table, it is generally occluded, for example, when moved by a hand, the object is occluded by the hand. Moreover, identification accuracy of such target object with a relatively high motion speed is relatively low. Therefore, in the embodiments of the present disclosure, only an occlusion state of the target object with to-be-determined state whose motion state satisfies the preset motion state condition is decided. That is, for a target object with to-be-determined state whose motion state satisfies the preset motion state condition, its occlusion state is determined according to its first detection result in the first image and the first detection result of the one or more other target objects in the first image.

In some embodiments, the first detection result of the target object in the first image includes a bounding box of the target object in the first image. In response to that the motion state of the target object with to-be-determined state satisfies the preset motion state condition, an occlusion state of the target object with to-be-determined state is determined according to an intersection over union between the bounding box of the target object with to-be-determined state and a bounding box of each of the one or more other target objects in the first image except the target object with to-be-determined state.

In one example, in the case that the motion state of the target object with to-be-determined state satisfies the preset motion state condition, the intersection over union between the bounding box of the target object with to-be-determined state and the bounding box of each of the one or more other target objects in the first image except the target object with to-be-determined state is obtained. In response to that none of the intersection over union between the bounding box of each of the one or more other target objects and the bounding box of the target object with to-be-determined state is greater than a set threshold, e.g., zero, it is determined that the target object with to-be-determined state is in an unoccluded state. In response to that the intersection over union between the bounding box of any of at least one of the one or more other target objects and the bounding box of the target object with to-be-determined state is greater than the set threshold, e.g., zero, it is determined that the target object with to-be-determined state is in an occluded state. There are two cases here, one is that the target object with to-be-determined state occludes at least one of other target objects, and the other is that the target object with to-be-determined state is occluded by at least one of other target objects.

In the embodiments of the present disclosure, the occlusion state of the target object with to-be-determined state is determined according to the intersection over union between the bounding box of the one or more other target objects in the first image and the bounding box of the target object with to-be-determined state, and the quality level of the image in the bounding box of the target object with to-be-determined state is determined according to the occlusion state. Thus, high-quality images for the target object with to-be-determined state can be filtered according to the quality level, thereby improving the identification efficiency.

In the embodiments of the present disclosure, an image collection device may be disposed around the target area to collect a video stream for the target area. Exemplarily, an image collection device (i.e., a top image collection device) may be disposed above the target area, so that the image collection device collects the video stream for the target area at a bird view. An image collection device (i.e., a side image collection device) may be disposed at a left side and/or a right side (or multiple sides) of the target area, so that the image collection device collects the video streams for the target area at a side view. An image collection device may also be disposed above the target area and disposed at the left and right sides (or multiple sides) of the target area, so that the image collection devices synchronous collect the video streams for the target area at the bird view and the side views.

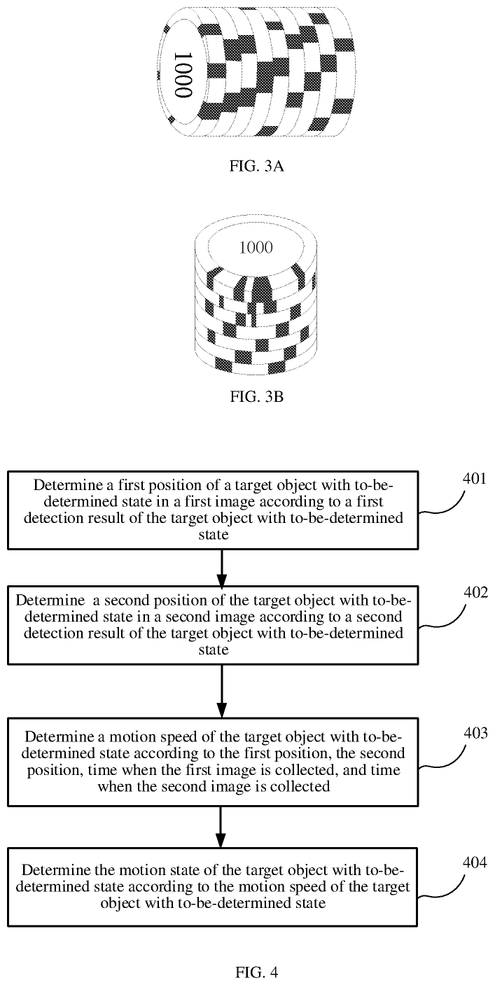

The classification of the target object with to-be-determined state may be determined according to the first detection result and/or the second detection result of the target object with to-be-determined state. Regarding a first-category target object, the video stream is collected at the bird view of the target area. That is, the video stream for the target area is collected by the image collection device disposed above the target area at the bird view. The first-category target object may include currency, cards, etc., and may also include game coins stacked in a horizontal direction and the like. FIG. 3A shows a schematic diagram of the game coins stacked in the horizontal direction, and the stacking mode may be referred to as a float stack. Persons skilled in the art should understand that the first-category target object may also include other items, or items placed in other forms, and is not limited to the above description.

In a case that the target object with to-be-determined state is the first-category target object, and the video stream is collected at the bird view of the target area, the occlusion state of the target object with to-be-determined state may be determined in the following ways: in response to that the motion state of the target object with to-be-determined state satisfies the preset motion state condition, while none of the intersection over union between the bounding box of the target object with to-be-determined state and the bounding box of each of the one or more other target objects in the first image except the target object with to-be-determined state is greater than zero, that is, there is no overlapping area between the bounding box of the target object with to-be-determined state and the bounding box of each of the one or more other target objects in the first image collected at the bird view, it is determined that the target object with to-be-determined state is in the unoccluded state. The other target objects may be, for example, a hand, a water glass, and the like. Persons skilled in the art should understand that the other target objects may be specifically set according to needs, which is not limited in the present disclosure.

In response to that the motion state of the target object with to-be-determined state satisfies the preset motion state condition, while the intersection over union between the bounding box of the target object with to-be-determined state and the bounding box of any of at least one of the one or more other target objects in the first image except the target object with to-be-determined state is greater than zero, that is, there is an overlapping area between the bounding box of the target object with to-be-determined state and the bounding box of any of at least one of the one or more other target objects in the first image collected at the bird view, it is determined that the target object with to-be-determined state the is in the occluded state.

Regarding a second-category target object, the video stream is collected at the side view of the target area. That is, the video stream for the target area is collected at the side view by the image collection device disposed at the side (the left side, the right side, or multiple sides) of the target area. The second-category target object may include game coins stacked in a vertical direction. FIG. 3B shows a schematic diagram of redeemed items stacked in the vertical direction, and the stacking mode may be referred to as a stand stack. Persons skilled in the art should understand that the second-category target object may also include other items, or items placed in other forms, and is not limited to the above description.

In a case that the target object with to-be-determined state is the second-category target object, and the video stream is collected at the side view of the target area, the occlusion state of the target object with to-be-determined state may be determined in the following ways: in response to that the motion state of the target object with to-be-determined state satisfies the preset motion state condition, while none of the intersection over union between the bounding box of the target object with to-be-determined state and the bounding box of each of the one or more other target objects in the first image except the target object with to-be-determined state is greater than zero, that is, there is no overlapping area between the bounding box of the target object with to-be-determined state and the bounding box of each of the one or more other target objects in the first image collected at the side view, it is determined that the target object with to-be-determined state is in the unoccluded state.

In response to that the motion state of the target object with to-be-determined state satisfies the preset motion state condition, while the intersection over union between the bounding box of the target object with to-be-determined state and the bounding box of any of at least one of the one or more other target objects in the first image except the target object with to-be-determined state is greater than zero, that is, there is an overlapping area between the bounding box of the target object with to-be-determined state and the bounding box of any of at least one of the one or more other target objects in the first image collected at the side view. Since an overlapping area which exists between two bounding boxes in the first image collected at the side view is related to relative positions between corresponding target objects in the two bounding boxes, and related to relative positions between two target objects and the image collection device, the occlusion state of the target object with to-be-determined state may further be determined according to a synchronous image collected synchronously with the first image from the bird view of the target area. For ease of description, a target object, whose intersection over union between the bounding box thereof and the bounding box of the target object with to-be-determined state is greater than zero in the first image collected at the side view, is referred to as a side-view occlusion object. There may be one or more side-view occlusion objects.

That is, relationship of the distance between the target object with to-be-determined state and an image collection device for collecting the video stream and the distance between each side-view occlusion object and the image collection device for collecting the video stream is determined according to a position of the target object with to-be-determined state in a synchronous image, a position of each side-view occlusion object in the synchronous image, and a position of the image collection device for collecting the video stream. Since the synchronous image is collected by an overhead image collection device from the bird view, after the positions of the target object with to-be-determined state and the side-view occlusion objects in the synchronous image are determined, and by combining the position of the image collection device for collecting the video stream, the relationship of the distances in the horizontal direction among the target object with to-be-determined state, the side-view occlusion objects, and the side image collection device may be determined.

In response to that the distance between the target object with to-be-determined state and the image collection device for collecting the video stream is less than the distance between any one of the side-view occlusion objects and the image collection device for collecting the video stream, it is determined that the target object with to-be-determined state is in the unoccluded state. That is, for each side-view occlusion object, when the distance between the target object with to-be-determined state and the image collection device is less than the distance between the target object with to-be-determined state and the side-view occlusion object, it may be determined that the target object with to-be-determined state is not occluded by the side-view occlusion object; if each of the side-view occlusion objects does not occlude the target object with to-be-determined state, it is determined that the target object with to-be-determined state is in the unoccluded state.

In response to that the distance between the target object with to-be-determined state and the image collection device for collecting the video stream is greater than or equal to a distance between one of the side-view occlusion objects and the image collection device for collecting the video stream, it is determined that the target object with to-be-determined state is in the occluded state. That is, for one side-view occlusion object, when the distance between the target object with to-be-determined state and the image collection device is greater than the distance between the target object with to-be-determined state and this side-view occlusion object, it may be determined that the target object with to-be-determined state is occluded by this side-view occlusion object, and thus, it is determined that the target object with to-be-determined state is in the occluded state.

FIG. 4 is a flowchart of a method of determining a motion state of a target object with to-be-determined state provided by at least one embodiment of the present disclosure. As shown in FIG. 4, the method includes steps 401 to 404.

At step 401, a first position of the target object with to-be-determined state in the first image is determined according to the first detection result of the target object with to-be-determined state.

The first position of the target object with to-be-determined state in the first image may be determined according to a position of the bounding box of the target object with to-be-determined state in the first detection result. For example, a central position of the bounding box may be used as the first position of the target object with to-be-determined state.

At step 402, a second position of the target object with to-be-determined state in the second image is determined according to the second detection result of the target object with to-be-determined state.

Similar to step 401, the second position of the target object with to-be-determined state in the second image may be determined according to a position of the bounding box of the target object with to-be-determined state in the second detection result.

At step 403, a motion speed of the target object with to-be-determined state is determined according to the first position, the second position, time when the first image is collected, and time when the second image is collected.

Change in positions of the target object with to-be-determined state in the first image and the second image may be determined according to the first position and the second position. Time corresponding to occurrence of the change in positions may be determined by combining the time when the first image is collected and the time when the second image is collected. Therefore, the motion speed of the target object with to-be-determined state in a pixel plane coordinate system (a uv coordinate system) can be determined.

At step 404, the motion state of the target object with to-be-determined state is determined according to the motion speed of the target object with to-be-determined state.

After the motion state of the target object with to-be-determined state is determined, whether the motion state of the target object with to-be-determined state satisfies a preset motion state condition is determined according to the motion speed and an image collection frame rate of the image collection device for collecting the video stream.

A motion speed threshold may be determined according to the image collection frame rate of the image collection device for collecting the video stream. When the motion speed of the target object with to-be-determined state in the uv coordinate system is less than the motion speed threshold, an target object captured by the image collection device is in a clear state, and the motion state in which the motion speed is less than the motion speed threshold may be determined as satisfying the preset motion state condition. When the motion speed of the target object with to-be-determined state in the uv coordinate system exceeds the motion speed threshold, the target object captured by the image collection device is in a motion blurring state, and the motion state in which the motion speed exceeds the motion speed threshold may be determined as dissatisfying the preset motion state condition.

In the embodiments of the present disclosure, the motion state of the target object with to-be-determined state is determined according to the motion speed of the target object with to-be-determined state, and then whether the motion state satisfies the preset motion state condition is determined. Thus, an image having a clear target object with to-be-determined state is filtered, thereby improving the identification efficiency.

In some embodiments, the state of the target object with to-be-determined state includes an occlusion state and a motion state. The occlusion state of the target object with to-be-determined state includes an unoccluded state and an occluded state. The motion state of the target object with to-be-determined state includes satisfying the preset motion state condition and dissatisfying the preset motion state condition.

According to the states above, the quality level of the image in the bounding box of the target object with to-be-determined state may be determined in the following ways.

I. In a case that the motion state of the target object with to-be-determined state satisfies the preset motion state condition, and the target object with to-be-determined state is in the unoccluded state, it is determined that the image in the bounding box of the target object with to-be-determined state is a first quality image. That is, the image in the bounding box corresponding to the target object with to-be-determined state that is not occluded by other objects and in a non-motion blurring state may be determined as the first quality image, i.e., the high-quality image.

II. In a case that the motion state of the target object with to-be-determined state satisfies the preset motion state condition, and the target object with to-be-determined state is in the occluded state, it is determined that the image in the bounding box of the target object with to-be-determined state is a second quality image. That is, the image in the bounding box corresponding to the target object with to-be-determined state that is occluded by other objects and in a non-motion blurring state may be determined as the second quality image, i.e., the medium-quality image.

III. In a case that the motion state of the target object with to-be-determined state dissatisfies the preset motion state condition, it is determined that the image in the bounding box of the target object with to-be-determined state is a third quality image. That is, the image in the bounding box corresponding to the target object with to-be-determined state that is in a motion blurring state may be determined as the third quality image, i.e., the low-quality image.

In the embodiments of the present disclosure, the quality level of the image in the bounding box of the target object is determined according to the occlusion state of the target object with to-be-determined state and whether the motion state satisfies the preset motion state condition, so that the frame image in the video stream is filtered according to the determined quality level. Thereby, the identification accuracy of a target object may be improved when the target object is identified by using the filtered image.

After the quality level of the image in the bounding box of the target object with to-be-determined state is obtained according to the foregoing method, a quality classification result of the image may further be obtained by using a neural network to verify the determined quality level. Then, a final target quality level is obtained.

First, the quality classification result of the image in the bounding box of the target object with to-be-determined state in the first image is determined by using the neural network.

The neural network may be trained by sample images annotated with the quality levels, and one sample image includes at least one target object with to-be-determined state. The sample image may determine the quality level according to the method of filtering images provided by at least one embodiment of the present disclosure, and is annotated with the determined quality level. For example, in a case that the image of the bounding box of the target object with to-be-determined state in an image is determined as the first quality image according to the method of filtering images provided by one of embodiments of the present disclosure, the image may be annotated as the first quality image, and the image is used as a sample image to train the neural network. Persons skilled in the art should understand that an image with a quality level determined by using other methods may be used as the sample image, to train the neural network. It should be noted that the annotated quality level of the sample image should be consistent with the image quality level determined according to the method of filtering images provided by the embodiments of the present disclosure.

In response to that the quality classification result of the image in the bounding box of the target object with to-be-determined state determined by the neural network is consistent with the quality level of the image in the bounding box of the target object with to-be-determined state determined according to the state of the target object with to-be-determined state, the quality level of the image in the bounding box of the target object with to-be-determined state is used as a target quality level of the image in the bounding box of the target object with to-be-determined state.

For an image frame in the video stream, the quality level of the image in the bounding box corresponding to the image frame is determined according to the state of the target object with to-be-determined state in the image by means of the method of filtering images provided by the embodiments of the present disclosure. Then, the quality classification result in the bounding box of the target object with to-be-determined state in the image is obtained according to the neural network. In the case that the quality classification result obtained by the neural network is consistent with the quality level determined according to the method of filtering images provided by the embodiments of the present disclosure, the quality level may be determined as the target quality level.

For example, in a case that the image of the bounding box of the target object with to-be-determined state in an image is determined as the first quality image according to the method of filtering images provided by one of the embodiments of the present disclosure, if the quality classification result obtained by the neural network is also the first quality image, it may be determined that the image in the bounding box of the target object with to-be-determined state in the image is the first quality image.

In the embodiments of the present disclosure, the quality classification result of the image in the bounding box of the target object with to-be-determined state is determined by the neural network. Thus, the quality level of the image is further verified, and the accuracy of the quality level classification of the image may be improved.

A target area 200 of the game table shown in FIG. 2 is taken as an example to describe the method of filtering images according to at least one embodiment of the present disclosure. Persons skilled in the art should understand that the method of filtering images may also be applied to other target areas, which is not limited to the target area of the game table.

An image collection device 211 disposed in an area 201 to the left of a dotted line A may be regarded as a side image collection device, which collects an image of the target area at a left side view. An image collection device 212 disposed in an area 202 to the right of a dotted line B may also be regarded as a side image collection device, which collects an image of the target area at a right side view. In addition, an overhead image collection device (not shown in FIG. 2) may be further provided above the target area 200 of the game table to collect an image of the target area at a bird view.

First, an image frame in a video stream, which is obtained by collecting images for a target area with any of the foregoing image collection devices, is obtained, and the image frame may be referred to as a first image. The first image may be an image collected at a bird view, or an image obtained from a side view.

Next, the first image is detected to obtain a first detection result of a target object in the first image. The target object in the first image may include a target object with to-be-determined state, and the target object with to-be-determined state is a target object for image quality filtering. In the table game scenario, the target object with to-be-determined state includes a first-category target object, e.g., game coins stacked in the horizontal direction (as shown in FIG. 3A), and a second-category target object, e.g., game coins stacked in the vertical direction (as shown in FIG. 3B). Other target object except the target object with to-be-determined state may include a hand. The obtained first detection result includes bounding boxes, positions and classification results of the target object with to-be-determined state and other target objects.

Next, a second detection result of the target object with to-be-determined state in a second image is obtained, where the second image is at least one image frame in N image frames adjacent to the first image. A state of the target object with to-be-determined state may be determined according to the first detection result and the second detection result, where the state includes an occlusion state and a motion state. The occlusion state includes an occluded state and an unoccluded state, and the motion state includes satisfying the preset motion state condition and dissatisfying the preset motion state condition.

The method of determining the occlusion state is described below.

For a first-category target object, e.g., game coins stacked in the horizontal direction, the occlusion state of the first-category target object may be determined by a first image collected with the overhead image collection device. For example, in a case that none of intersection over union between a bounding box of the horizontally stacked game coins in the first image and a bounding box of each hand detected is greater than zero, it is determined that the horizontally stacked game coins are in the unoccluded state. On the contrary, in a case that the intersection over union between the bounding box of the horizontally stacked game coins in the first image and a bounding box of one of the hands detected is greater than zero, it is determined that the horizontally stacked game coins are in the occluded state.

For a second-category target object, e.g., game coins stacked in the vertical direction, the occlusion state of the second-category target object may be determined by a first image collected with the side image collection device. For example, in a case that none of intersection over union between a bounding box of the vertically stacked game coins in the first image and a bounding box of each hand detected is greater than zero, it is determined that the vertically stacked game coins are in the unoccluded state.

In a case that the intersection over union between the bounding box of the vertically stacked game coins in the first image and a bounding box of one of the hands detected is greater than zero, it is necessary to further use the position relationship of the vertically stacked game coins, the hand, and the side image collection device for determining the occlusion state of the vertically stacked game coins. For ease of description, a hand with the intersection over union between the bounding boxes greater than zero is called occlusion hand.

In one example, the position relationship of the vertically stacked game coins, the hand, and the side image collection device may be determined by a synchronous image collected by the overhead image collection device. For example, a distance between the vertically stacked game coins and the side image collection device, and a distance between the occlusion hand and the side image collection device may be determined according to a position of the vertically stacked game coins in the synchronous image, a position of the occlusion hand in the synchronous image, and a position of the side image collection device.

In a case that the distance between the vertically stacked game coins and the side image collection device is less than the distance between the occlusion hand and the side image collection device, it may be determined that the vertically stacked game coins are in the unoccluded state. On the contrary, in a case that the distance between the vertically stacked game coins and the side image collection device is greater than the distance between the occlusion hand and the side image collection device, it may be determined that the vertically stacked game coins are in the occluded state.

The method of determining the motion state is described below.

First, a first position of the target object with to-be-determined state in the first image is determined according to the first detection result of the target object with to-be-determined state. The target object with to-be-determined state includes game coins stacked in the horizontal direction and/or game coins stacked in the vertical direction, which are all referred to as stacked game coins for ease of descriptions. That is, a first position of the stacked game coins in the first image is determined firstly.

Next, a second position of the stacked game coins in the second image is determined according to the second detection result of the stacked game coins. Taking the second image to be an image frame in N image frames adjacent to the first image as an example, a position of stacked game coins in an image frame in front of the first image is obtained.

Motion speed of the stacked game coins in the uv coordinate system may be determined according to time when the first image is collected, time when the second image is collected, the first position, and the second position. Thus, the motion state of the stacked game coins may be determined.

A corresponding motion speed threshold may be obtained according to the image collection frame rate of the image collection device for collecting the video stream. In a case that the motion speed of the stacked game coins in the uv coordinate system is less than or equal to the motion speed threshold, it may be determined that the motion state satisfies the preset motion state condition. In a case that the motion speed of the stacked game coins in the uv coordinate system is greater than the motion speed threshold, it may be determined that the motion state dissatisfies the preset motion state condition.

A quality level of an image in the bounding box of the stacked game coins may be determined according to the determined occlusion state and the motion state of the stacked game coins.

For example, in a case that the motion state of the stacked game coins satisfies the preset motion state condition, and the stacked game coins are in the unoccluded state, the image in the bounding box of the stacked game coins is a first quality image. In a case that the motion state of the stacked game coins satisfies the preset motion state condition, and the stacked game coins are in the occluded state, the image in the bounding box of the stacked game coins is a second quality image. In a case that the motion state of the stacked game coins dissatisfies the preset motion state condition, the image in the bounding box of the stacked game coins is a third quality image.

The first image or the image in the bounding box of the stacked game coins in the first image are filtered according to the quality level of the image in the bounding box of the stacked game coins, so that the identification efficiency and accuracy of the stacked game coins may be improved when the stacked game coins are identified with the filtered image.

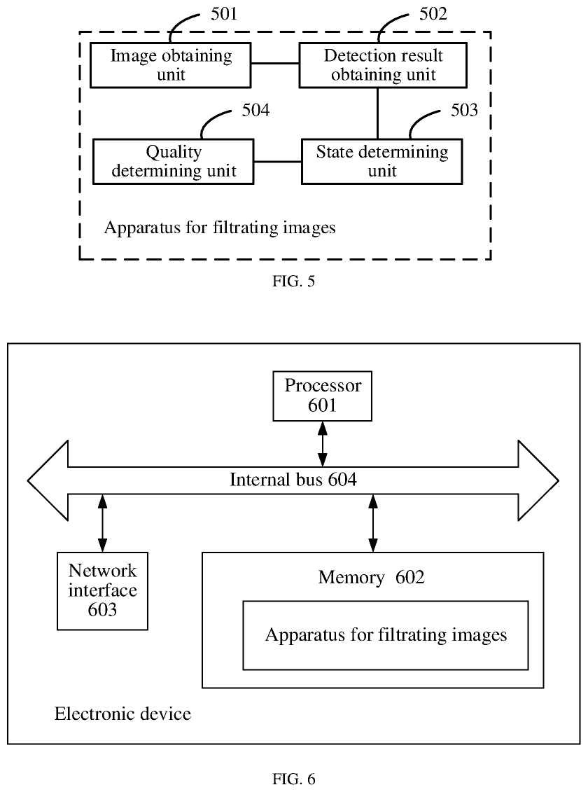

As shown in FIG. 5, at least one embodiment of the present disclosure also provides an apparatus for filtering images, including: an image obtaining unit 501, configured to obtain a first image, wherein the first image is an image frame in a video stream obtained by collecting images for a target area; a detection result obtaining unit 502, configured to obtain a first detection result of a target object in the first image by detecting the first image; a state determining unit 503, configured to determine a state of a target object with to-be-determined state according to the first detection result of the target object in the first image and a second detection result of the target object with to-be-determined state, where the target object with to-be-determined state is a target object in the first image, the second detection result of the target object with to-be-determined state is a detection result of the target object with to-be-determined state in a second image obtained by detecting the second image, the second image is at least one image frame in N image frames adjacent to the first image in the video stream, and N is a positive integer; and a quality determining unit 504, configured to determine a quality level of an image in a bounding box of the target object with to-be-determined state according to the state of the target object with to-be-determined state, wherein the bounding box of the target object with to-be-determined state is determined according to the first detection result of the target object with to-be-determined state.

In some embodiments, the state determining unit 503 is specifically configured to: determine a motion state of the target object with to-be-determined state according to the first detection result of the target object with to-be-determined state and the second detection result of the target object with to-be-determined state; determine whether the motion state of the target object with to-be-determined state satisfies a preset motion state condition; and in response to that the motion state of the target object with to-be-determined state satisfies the preset motion state condition, determine the occlusion state of the target object with to-be-determined state according to the first detection result of the target object with to-be-determined state and a first detection result of one or more other target objects in the first image except the target object with to-be-determined state.

In some embodiments, the first detection result of the target object in the first image includes a bounding box of the target object in the first image, and the state determining unit 503 is specifically configured to: in response to that the motion state of the target object with to-be-determined state satisfies the preset motion state condition, determine the occlusion state of the target object with to-be-determined state according to an intersection over union between the bounding box of the target object with to-be-determined state and a bounding box of each of the one or more other target objects in the first image except the target object with to-be-determined state.

In some embodiments, the target object with to-be-determined state is a first-category target object, and the video stream is collected at a bird view of the target area; and the state determining unit 503 is specifically configured to: in response to that the motion state of the target object with to-be-determined state satisfies the preset motion state condition, and none of the intersection over union between the bounding box of the target object with to-be-determined state and the bounding box of each of the one or more other target objects in the first image except the target object with to-be-determined state is greater than zero, determine that the target object with to-be-determined state is in an unoccluded state; and in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determine that the target object with to-be-determined state is in an occluded state.

In some embodiments, the target object with to-be-determined state is a second-category target object, and the video stream is collected at a side view of the target area; and the state determining unit 503 is specifically configured to: in response to that the motion state of the target object with to-be-determined state satisfies the preset motion state condition, and none of the intersection over union of the bounding box of the target object with to-be-determined state and the bounding box of each of the one or more other target objects in the first image except the target object with to-be-determined state is greater than zero, determine that the target object with to-be-determined state is in an unoccluded state.

In some embodiments, the target object with to-be-determined state is a second-category target object, and the video stream is collected at a side view of the target area; and the state determining unit 503 is specifically configured to: in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determine, according to a position of the target object with to-be-determined state in a synchronous image, one or more positions of one or more side-view occlusion objects in the synchronous image, and a position of an image collection device for collecting the video stream, whether a distance between the target object with to-be-determined state and the image collection device for collecting the video stream is less than a distance between each of the side-view occlusion objects and the image collection device for collecting the video stream, wherein the synchronous image is collected synchronously with the first image at a bird view of the target area, and the side-view occlusion object is a target object whose intersection over union between a bounding box thereof and the bounding box of the target object with to-be-determined state is greater than zero; in response to that the distance between the target object with to-be-determined state and the image collection device for collecting the video stream is less than a distance between each of the one or more side-view occlusion objects and the image collection device for collecting the video stream, determine that the target object with to-be-determined state is in an unoccluded state; and in response to that the distance between the target object with to-be-determined state and the image collection device for collecting the video stream is greater than a distance between one side-view occlusion object and the image collection device for collecting the video stream, determine that the target object with to-be-determined state is in an occluded state.

In some embodiments, the state determining unit 503 is specifically configured to: determine a first position of the target object with to-be-determined state in the first image according to the first detection result of the target object with to-be-determined state; determine a second position of the target object with to-be-determined state in the second image according to the second detection result of the target object with to-be-determined state; determine a motion speed of the target object with to-be-determined state according to the first position, the second position, time when the first image is collected, and time when the second image is collected; and determine the motion state of the target object with to-be-determined state according to the motion speed of the target object with to-be-determined state. The state determining unit is specifically configured to: determine whether the motion state of the target object with to-be-determined state satisfies the preset motion state condition according to the motion speed of the target object with to-be-determined state and an image collection frame rate of an image collection device for collecting the video stream.

In some embodiments, the state of the target object with to-be-determined state includes an occlusion state and a motion state, the occlusion state of the target object with to-be-determined state includes an unoccluded state and an occluded state, and the motion state of the target object with to-be-determined state includes satisfying a preset motion state condition and dissatisfying the preset motion state condition. The quality determining unit 504 is specifically configured to: in response to that the motion state of the target object with to-be-determined state satisfies the preset motion state condition, and the target object with to-be-determined state is in the unoccluded state, determine that the image in the bounding box of the target object with to-be-determined state is a first quality image; in response to that the motion state of the target object with to-be-determined state satisfies the preset motion state condition, and the target object with to-be-determined state is in the occluded state, determine that the image in the bounding box of the target object with to-be-determined state is a second quality image; and in response to that the motion state of the target object with to-be-determined state dissatisfies the preset motion state condition, determine that the image in the bounding box of the target object with to-be-determined state is a third quality image.

With reference to any implementation provided by the present disclosure, the apparatus further includes: a classification unit, configured to determine a quality classification result of the image in the bounding box of the target object with to-be-determined state in the first image by a neural network, where the neural network is trained with sample images annotated with quality levels, and one sample image includes at least one target object with to-be-determined state; and in response to that the quality classification result of the image in the bounding box of the target object with to-be-determined state determined by the neural network is consistent with the quality level of the image in the bounding box of the target object with to-be-determined state determined according to the state of the target object with to-be-determined state, take the quality level of the image in the bounding box of the target object with to-be-determined state as a target quality level of the image in the bounding box of the target object with to-be-determined state.

In some embodiments, the functions provided by or the modules included in the apparatuses provided in the embodiments of the present disclosure may be used to implement the methods described in the foregoing method embodiments. For specific implementations, reference may be made to the description in the method embodiments above. For the purpose of brevity, details are not described here repeatedly.

The apparatus embodiments described above are merely illustrative, where the modules described as separate components may or may not be physically separated, and the components displayed as modules may or may not be physical modules, that is, may be located a same position, or may also be distributed to multiple network modules. Some or all of the modules may be selected according to actual requirements to achieve the objectives of the solutions in the specification. A person of ordinary skill in the art may understand and implement without involving any inventive effort.

The apparatus embodiments of the present disclosure may be applied to computer devices, such as a server or a terminal device. The apparatus embodiments may be implemented by software, or may be implemented by hardware or a combination of hardware and software. Taking the software implementation as an example, a logical apparatus is formed by reading a corresponding computer program instruction in a non-volatile memory into a processor for processing. From a hardware aspect, FIG. 6 shows a hardware structure diagram of an electronic device in which the apparatus in the specification is located. In addition to a processor 601, an internal bus 604, a network interface 603, and a non-volatile memory 602 as shown in FIG. 6, the server or the electronic device in which the apparatus in the embodiments is located may also include other hardware according to the actual function of the computer device, and details are not described herein.

Accordingly, the embodiments of the present disclosure also provide a computer storage medium having a computer program stored thereon. When the program is executed by a processor, the program causes a processor to implement the method of filtering images according to any embodiment.

Accordingly, the embodiments of the present disclosure also provide a computer device, including a memory, a processor, and a computer program stored on the memory and executed by the processor. When the program is executed by the processor, the method of filtering images according to any embodiment is implemented.

The present disclosure may take the form of a computer program product implemented on one or more storage media (including but not limited to a disk memory, a CD-ROM, an optical memory, etc.) including program codes. Computer-usable storage media includes permanent and non-permanent, removable and non-removable media, and may implement storage for information by means of any method or technology. The information may be computer-readable commands, data structures, modules of programs, or other data. Examples of computer storage media include, but are not limited to: Phase-change Random Access Memory (PRAM), Static Random Access Memory (SRAM), Dynamic Random Access Memory (DRAM), other types of Random Access Memories (RAMs), Read-Only Memory (ROM), Electrically Erasable Programmable Read-Only Memory (EEPROM), flash memory or other memory technologies, Compact Disk Read Only Memory (CD-ROM), Digital Versatile Disc (DVD) or other optical storage, magnetic cassettes, magnetic tape storage or other magnetic storage devices or any other non-transmitting medium that may be used to store information that may be accessed by a computing device.

Persons skilled in the art would easily conceive of other embodiments of the present disclosure after considering the specification and practicing the specification disclosed herein. The present disclosure is intended to cover any variations, uses, or adaptive changes of the present disclosure. These variations, uses, or adaptive changes conform to the general principles of the present disclosure and include the common general knowledge or conventional technical measures in the technical field that are not disclosed in the present disclosure. The specification and embodiments are considered as exemplary only, and the real scope and spirit of the present disclosure are indicated by the following claims.

It should be understood that the present disclosure is not limited to the precise structure that is described above and illustrated in the drawings, and various modifications and changes may be made without departing from the scope thereof. The scope of the present disclosure is limited only by the following claims.

The above are only some embodiments of the present disclosure, and are not intended to limit the present disclosure. Any modification, equivalent substitution, improvement, etc. made within the spirit and principle of the present disclosure should be included in the scope of protection of the present disclosure.

The foregoing descriptions of various embodiments emphasize differences between the embodiments. For a same or similar part, reference may be made to each other. For brevity, details are not described again.

1. A method of filtering images, comprising:
obtaining a first image, wherein the first image is an image frame in a video stream obtained by collecting images for a target area;
obtaining a first detection result of a target object in the first image by detecting the first image;
determining a state of a target object with to-be-determined state according to the first detection result of the target object in the first image and a second detection result of the target object with to-be-determined state, wherein
the target object with to-be-determined state is a target object in the first image,
the second detection result of the target object with to-be-determined state is a detection result of the target object with to-be-determined state in a second image obtained by detecting the second image,
the second image is at least one image frame in N image frames adjacent to the first image in the video stream, and
N is a positive integer; and
determining a quality level of an image in a bounding box of the target object with to-be-determined state according to the state of the target object with to-be-determined state, wherein the bounding box of the target object with to-be-determined state is determined according to the first detection result of the target object with to-be-determined state.

2. The method according to claim 1, wherein the state of the target object with to-be-determined state comprises an occlusion state and a motion state, and determining the state of the target object with to-be-determined state according to the first detection result of the target object in the first image and the second detection result of the target object with to-be-determined state comprises:
determining a motion state of the target object with to-be-determined state according to the first detection result of the target object with to-be-determined state and the second detection result of the target object with to-be-determined state;
determining whether the motion state of the target object with to-be-determined state satisfies a preset motion state condition; and
in response to that the motion state of the target object with to-be-determined state satisfies the preset motion state condition, determining the occlusion state of the target object with to-be-determined state according to the first detection result of the target object with to-be-determined state and a first detection result of one or more other target objects in the first image except the target object with to-be-determined state.

3. The method according to claim 2, wherein the first detection result of the target object in the first image comprises a bounding box of the target object in the first image, and in response to that the motion state of the target object with to-be-determined state satisfies the preset motion state condition, determining the occlusion state of the target object with to-be-determined state according to the first detection result of the target object with to-be-determined state and the first detection result of the one or more other target objects in the first image except the target object with to-be-determined state comprises:
in response to that the motion state of the target object with to-be-determined state satisfies the preset motion state condition, determining the occlusion state of the target object with to-be-determined state according to an intersection over union between the bounding box of the target object with to-be-determined state and a bounding box of each of the one or more other target objects in the first image except the target object with to-be-determined state.

4. The method according to claim 3, wherein the target object with to-be-determined state is a first-category target object, and the video stream is collected at a bird view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and none of the intersection over union between the bounding box of the target object with to-be-determined state and the bounding box of each of the one or more other target objects in the first image except the target object with to-be-determined state is greater than zero, determining that the target object with to-be-determined state is in an unoccluded state; and
in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determining that the target object with to-be-determined state is in an occluded state.

5. The method according to claim 3, wherein the target object with to-be-determined state is a second-category target object, and the video stream is collected at a side view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and none of the intersection over union of the bounding box of the target object with to-be-determined state and the bounding box of each of the one or more other target objects in the first image except the target object with to-be-determined state is greater than zero, determining that the target object with to-be-determined state is in an unoccluded state.

6. The method according to claim 3, wherein the target object with to-be-determined state is a second-category target object, and the video stream is collected at a side view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determining, according to a position of the target object with to-be-determined state in a synchronous image, one or more positions of one or more side-view occlusion objects in the synchronous image, and a position of an image collection device for collecting the video stream, whether a distance between the target object with to-be-determined state and the image collection device for collecting the video stream is less than a distance between each of the side-view occlusion objects and the image collection device for collecting the video stream, wherein
the synchronous image is collected synchronously with the first image at a bird view of the target area, and
the side-view occlusion object is a target object whose intersection over union between a bounding box thereof and the bounding box of the target object with to-be-determined state is greater than zero;
in response to that the distance between the target object with to-be-determined state and the image collection device for collecting the video stream is less than a distance between each of the one or more side-view occlusion objects and the image collection device for collecting the video stream, determining that the target object with to-be-determined state is in an unoccluded state; and
in response to that the distance between the target object with to-be-determined state and the image collection device for collecting the video stream is greater than a distance between one side-view occlusion object and the image collection device for collecting the video stream, determining that the target object with to-be-determined state is in an occluded state.

7. The method according to claim 2, wherein determining the motion state of the target object with to-be-determined state according to the first detection result of the target object with to-be-determined state and the second detection result of the target object with to-be-determined state comprises:
determining a first position of the target object with to-be-determined state in the first image according to the first detection result of the target object with to-be-determined state;
determining a second position of the target object with to-be-determined state in the second image according to the second detection result of the target object with to-be-determined state;
determining a motion speed of the target object with to-be-determined state according to the first position, the second position, time when the first image is collected, and time when the second image is collected; and
determining the motion state of the target object with to-be-determined state according to the motion speed of the target object with to-be-determined state; and
determining whether the motion state of the target object with to-be-determined state satisfies the preset motion state condition comprises:
determining whether the motion state of the target object with to-be-determined state satisfies the preset motion state condition according to the motion speed of the target object with to-be-determined state and an image collection frame rate of an image collection device for collecting the video stream.

8. The method according to claim 1, wherein the state of the target object with to-be-determined state comprises an occlusion state and a motion state, the occlusion state of the target object with to-be-determined state comprises an unoccluded state and an occluded state, and the motion state of the target object with to-be-determined state comprises satisfying a preset motion state condition and dissatisfying the preset motion state condition;
determining the quality level of the image in the bounding box of the target object with to-be-determined state according to the state of the target object with to-be-determined state comprises:
in response to that the motion state of the target object with to-be-determined state satisfies the preset motion state condition, and the target object with to-be-determined state is in the unoccluded state, determining that the image in the bounding box of the target object with to-be-determined state is a first quality image;
in response to that the motion state of the target object with to-be-determined state satisfies the preset motion state condition, and the target object with to-be-determined state is in the occluded state, determining that the image in the bounding box of the target object with to-be-determined state is a second quality image; and
in response to that the motion state of the target object with to-be-determined state dissatisfies the preset motion state condition, determining that the image in the bounding box of the target object with to-be-determined state is a third quality image.

9. The method according to claim 1, further comprising:
determining a quality classification result of the image in the bounding box of the target object with to-be-determined state in the first image by a neural network, wherein the neural network is trained with sample images annotated with quality levels, and one sample image comprises at least one target object with to-be-determined state; and
in response to that the quality classification result of the image in the bounding box of the target object with to-be-determined state determined by the neural network is consistent with the quality level of the image in the bounding box of the target object with to-be-determined state determined according to the state of the target object with to-be-determined state, taking the quality level of the image in the bounding box of the target object with to-be-determined state as a target quality level of the image in the bounding box of the target object with to-be-determined state.

10. An electronic device, comprising:
a memory and a processor,
wherein the memory is configured to store computer instructions executed by the processor, and the processor is configured to:
obtain a first image, wherein the first image is an image frame in a video stream obtained by collecting images for a target area;
obtain a first detection result of a target object in the first image by detecting the first image;
determine a state of a target object with to-be-determined state according to the first detection result of the target object in the first image and a second detection result of the target object with to-be-determined state, wherein
the target object with to-be-determined state is a target object in the first image,
the second detection result of the target object with to-be-determined state is a detection result of the target object with to-be-determined state in a second image obtained by detecting the second image,
the second image is at least one image frame in N image frames adjacent to the first image in the video stream, and
N is a positive integer; and
determine a quality level of an image in a bounding box of the target object with to-be-determined state according to the state of the target object with to-be-determined state, wherein the bounding box of the target object with to-be-determined state is determined according to the first detection result of the target object with to-be-determined state.

11. The electronic device according to claim 10, wherein the state of the target object with to-be-determined state comprises an occlusion state and a motion state, and determining the state of the target object with to-be-determined state according to the first detection result of the target object in the first image and the second detection result of the target object with to-be-determined state comprises:
determining a motion state of the target object with to-be-determined state according to the first detection result of the target object with to-be-determined state and the second detection result of the target object with to-be-determined state;
determining whether the motion state of the target object with to-be-determined state satisfies a preset motion state condition; and
in response to that the motion state of the target object with to-be-determined state satisfies the preset motion state condition, determining the occlusion state of the target object with to-be-determined state according to the first detection result of the target object with to-be-determined state and a first detection result of one or more other target objects in the first image except the target object with to-be-determined state.

12. The electronic device according to claim 11, wherein the first detection result of the target object in the first image comprises a bounding box of the target object in the first image, and in response to that the motion state of the target object with to-be-determined state satisfies the preset motion state condition, determining the occlusion state of the target object with to-be-determined state according to the first detection result of the target object with to-be-determined state and the first detection result of the one or more other target objects in the first image except the target object with to-be-determined state comprises:
in response to that the motion state of the target object with to-be-determined state satisfies the preset motion state condition, determining the occlusion state of the target object with to-be-determined state according to an intersection over union between the bounding box of the target object with to-be-determined state and a bounding box of each of the one or more other target objects in the first image except the target object with to-be-determined state.

13. The electronic device according to claim 12, wherein the target object with to-be-determined state is a first-category target object, and the video stream is collected at a bird view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and none of the intersection over union between the bounding box of the target object with to-be-determined state and the bounding box of each of the one or more other target objects in the first image except the target object with to-be-determined state is greater than zero, determining that the target object with to-be-determined state is in an unoccluded state; and
in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determining that the target object with to-be-determined state is in an occluded state.

14. The electronic device according to claim 12, wherein the target object with to-be-determined state is a second-category target object, and the video stream is collected at a side view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and none of the intersection over union of the bounding box of the target object with to-be-determined state and the bounding box of each of the one or more other target objects in the first image except the target object with to-be-determined state is greater than zero, determining that the target object with to-be-determined state is in an unoccluded state.

15. The electronic device according to claim 12, wherein the target object with to-be-determined state is a second-category target object, and the video stream is collected at a side view of the target area; and in response to that the motion state of the target object with to-be-determined state satisfies the preset motion state condition, determining the occlusion state of the target object with to-be-determined state according to the intersection over union between the bounding box of the target object with to-be-determined state and the bounding box of each of the one or more other target objects in the first image except the target object with to-be-determined state comprises:
in response to that the motion state of the target object with to-be-determined state satisfies the preset motion state condition, and an intersection over union between the bounding box of the target object with to-be-determined state and a bounding box of any of at least one of the one or more other target objects in the first image except the target object with to-be-determined state is greater than zero, determining, according to a position of the target object with to-be-determined state in a synchronous image, one or more positions of one or more side-view occlusion objects in the synchronous image, and a position of an image collection device for collecting the video stream, whether a distance between the target object with to-be-determined state and the image collection device for collecting the video stream is less than a distance between each of the side-view occlusion objects and the image collection device for collecting the video stream, wherein
the synchronous image is collected synchronously with the first image at a bird view of the target area, and
the side-view occlusion object is a target object whose intersection over union between a bounding box thereof and the bounding box of the target object with to-be-determined state is greater than zero;
in response to that the distance between the target object with to-be-determined state and the image collection device for collecting the video stream is less than a distance between each of the one or more side-view occlusion objects and the image collection device for collecting the video stream, determining that the target object with to-be-determined state is in an unoccluded state; and
in response to that the distance between the target object with to-be-determined state and the image collection device for collecting the video stream is greater than a distance between one side-view occlusion object and the image collection device for collecting the video stream, determining that the target object with to-be-determined state is in an occluded state.

16. The electronic device according to claim 11, wherein determining the motion state of the target object with to-be-determined state according to the first detection result of the target object with to-be-determined state and the second detection result of the target object with to-be-determined state comprises:
determining a first position of the target object with to-be-determined state in the first image according to the first detection result of the target object with to-be-determined state;
determining a second position of the target object with to-be-determined state in the second image according to the second detection result of the target object with to-be-determined state;
determining a motion speed of the target object with to-be-determined state according to the first position, the second position, time when the first image is collected, and time when the second image is collected; and
determining the motion state of the target object with to-be-determined state according to the motion speed of the target object with to-be-determined state; and
determining whether the motion state of the target object with to-be-determined state satisfies the preset motion state condition comprises:
determining whether the motion state of the target object with to-be-determined state satisfies the preset motion state condition according to the motion speed of the target object with to-be-determined state and an image collection frame rate of an image collection device for collecting the video stream.

17. The electronic device according to claim 10, wherein the state of the target object with to-be-determined state comprises an occlusion state and a motion state, the occlusion state of the target object with to-be-determined state comprises an unoccluded state and an occluded state, and the motion state of the target object with to-be-determined state comprises satisfying a preset motion state condition and dissatisfying the preset motion state condition;
determining the quality level of the image in the bounding box of the target object with to-be-determined state according to the state of the target object with to-be-determined state comprises:
in response to that the motion state of the target object with to-be-determined state satisfies the preset motion state condition, and the target object with to-be-determined state is in the unoccluded state, determining that the image in the bounding box of the target object with to-be-determined state is a first quality image;
in response to that the motion state of the target object with to-be-determined state satisfies the preset motion state condition, and the target object with to-be-determined state is in the occluded state, determining that the image in the bounding box of the target object with to-be-determined state is a second quality image; and
in response to that the motion state of the target object with to-be-determined state dissatisfies the preset motion state condition, determining that the image in the bounding box of the target object with to-be-determined state is a third quality image.

18. The electronic device according to claim 10, the processor is further configured to:
determine a quality classification result of the image in the bounding box of the target object with to-be-determined state in the first image by a neural network, wherein the neural network is trained with sample images annotated with quality levels, and one sample image comprises at least one target object with to-be-determined state; and
in response to that the quality classification result of the image in the bounding box of the target object with to-be-determined state determined by the neural network is consistent with the quality level of the image in the bounding box of the target object with to-be-determined state determined according to the state of the target object with to-be-determined state, take the quality level of the image in the bounding box of the target object with to-be-determined state as a target quality level of the image in the bounding box of the target object with to-be-determined state.

19. A non-volatile computer-readable storage medium having a computer program stored thereon, wherein the program is executable by a processor to:
obtain a first image, wherein the first image is an image frame in a video stream obtained by collecting images for a target area;
obtain a first detection result of a target object in the first image by detecting the first image;
determine a state of a target object with to-be-determined state according to the first detection result of the target object in the first image and a second detection result of the target object with to-be-determined state, wherein
the target object with to-be-determined state is a target object in the first image,
the second detection result of the target object with to-be-determined state is a detection result of the target object with to-be-determined state in a second image obtained by detecting the second image,
the second image is at least one image frame in N image frames adjacent to the first image in the video stream, and
N is a positive integer; and
determine a quality level of an image in a bounding box of the target object with to-be-determined state according to the state of the target object with to-be-determined state, wherein the bounding box of the target object with to-be-determined state is determined according to the first detection result of the target object with to-be-determined state.
